(19) United States
(12) Patent Application Publication
(10) Pub. No.: US 2016/0127188 A1
(43) Pub. Date: May 5, 2016

(54) METHOD FOR OPERATING RELATION SERVER IN NESTED-CENTRALIZED MODEL AND SYSTEM USING THE SAME

(71) Applicant: ELECTRONICS AND TELECOMMUNICATIONS RESEARCH INSTITUTE, Daejeon (KR)

(72) Inventors: Young-Sic JEONG, Daejeon (KR); Sang-Keun YOO, Sejong (KR); Yong-Woon KIM, Asan-si (KR)

(21) Appl. No.: 14/931,232

(22) Filed: Nov. 3, 2015

(30) Foreign Application Priority Data
Nov. 3, 2014 (KR) 10-2014-0151327
Nov. 3, 2014 (KR) 10-2014-0151328
Jan. 23, 2015 (KR) 10-2015-0011217
Jun. 30, 2015 (KR) 10-2015-0093339
Oct. 19, 2015 (KR) 10-2015-0145571
Nov. 3, 2015 (KR) 10-2015-0153934

(51) Int. Cl. H04L 12/24; H04L 29/08

(52) U.S. Cl. CPC H04L 41/0893; H04L 67/303

(57) ABSTRACT

Disclosed herein are a method for operating a relation server in a hybrid model and a system using the method. The method for operating a relation server includes generating, by the relation server, a capability set required to execute a command by analyzing the command, grouping, by the relation server, machines that are to execute the command, based on the generated capability set, capability parameters and status parameters of respective machines that are previously registered in the relation server or that are extractable by the relation server, and generating, by the relation server, relations using sub-relations formed by a machine group grouped by the relation server and a sub-relation server.

### CROSS REFERENCE TO RELATED APPLICATIONS

This application claims the benefit of Korean Patent Application Nos. 10-2014-0151328, filed Nov. 3, 2014, 10-2014-0151327, filed Nov. 3, 2014, 10-2015-0011217, filed Jan. 23, 2015, 10-2015-0093339, filed Jun. 30, 2015, 10-2015-0145571, filed Oct. 19, 2015 and 10-2015-0153934, filed Nov. 3, 2015 which are hereby incorporated by reference in their entirety into this application.

### BACKGROUND OF THE INVENTION

1. Technical Field

Embodiments based on the concept of the present invention generally relate to a method for operating a relation server and a system using the method and, more particularly, to a method for operating a relation server and a system using the method, which manage relations between machines that are required in order to execute received commands by utilizing sub-relations between the machines.

2. Description of the Related Art

Recently, systems for connecting machines through a network and sharing information between the machines have been applied to various fields, such as health care, telemetry, smart homes, and smart cars, as well as household appliances and electronic devices.

Therefore, when various machines form collaborative relations, methods for managing the relations between the machines are required.

### SUMMARY OF THE INVENTION

Accordingly, the present invention has been made keeping in mind the above problems occurring in the prior art, and an object of the present invention is to provide a method for operating a relation server and a system using the method, which manage relations between machines that are required in order to execute received commands by utilizing sub-relations between the machines.

In accordance with an aspect of the present invention to accomplish the above object, there is provided a method for
operating a relation server, comprising:
generating, by a relation server, a capability set required to execute a command by analyzing the command;
grouping, by the relation server, machines that are to execute the command, based on the generated capability set, capability parameters and status parameters of respective machines that are previously registered in the relation server or that are extractable by the relation server; and
generating, by the relation server, relations using sub-relations formed by a machine group grouped by the relation server and a sub-relation server.

Each of the capability parameters may include sub-parameters related to at least one of a title of an executable process, an input parameter, an output parameter, a process processing time, process processing conditions, and executable functions.

Each of the status parameters includes sub-parameters related to at least one of a current active state, current availability or unavailability, a current process, a scheduled termination time for the current process state, a currently executed function, and a scheduled termination time of the currently executed function.

A machine profile including information about each of the machines may include a capability parameter and a status parameter, and the machine profile may further include at least one of a machine ID parameter, a user ID parameter, a group ID parameter, a machine operating system parameter, and a machine interface parameter.

The machine operating system parameter may include sub-parameters related to a type and a version of an operating system used by each of the machines.

The machine interface parameter may include sub-parameters related to interfaces and interface protocols between the machines, interfaces and interface protocols between each machine and the relation server, and interfaces and interface protocols between each machine and the sub-relation server.

The sub-relation server may sub-group machines that are to execute the command together, based on the capability set generated as a result of analysis on the command by the sub-relation server itself and capability parameters and status parameters of respective machines that are previously registered in the sub-relation server or that are extractable by the sub-relation server, and forms the sub-relations of sub-grouped machines.

The sub-relation may include information about the sub-grouped machines and information about a task processing schedule of the sub-grouped machines

The relations may include information about the grouped machines grouped by the relation server, information about the sub-grouped machines sub-grouped by the sub-relation server and information about a total task processing schedule.

The method may further include generating, by the relation server, a relation profile based on the relations.

The method may further include transmitting, by the relation server, the relation profile to the sub-relation server.

The relation profile may include at least one of a capability set parameter, grouped machine parameters, a work group ID parameter, a task description parameter, and a task processing schedule parameter.

The task processing schedule parameter may include sub-parameters related to at least one of a process start time of each process, process start conditions, machine IDs of allocated machines, functions that are used, a start time of each of the functions, a predicted process termination time, interface parameters, and process termination conditions.

The method may further include operating, by the relation server, the grouped machines according to a task processing schedule of operations included in the relation profile.

The method may further include, after completing the execution of the command, releasing, by the relation server, the relations, and releasing, by the sub-relation server, the sub-relations.

The method may further include requesting, by the relation server, an intervention of a user based on processes included in the relation profile.

The intervention of the user may include an approval or a selection of the user related to an execution of the process.

The method may further include re-grouping, by the relation server, the machines according to the approval or the selection of the user, and forming, by the relation server, new relations between the re-grouped machines.

The method may further include generating, by the relation server, a new work profile based on the new relations.

In accordance with another aspect of the present invention to accomplish the above object, there is provided a system including multiple first machines, multiple second machines, a sub-relation server for managing sub-relations between the multiple second machines, and a relation server for managing relations between the first machines and the second machines using the sub-relations, wherein the relation server generates a capability set required to execute a command by analyzing the command, and form relations between machines that are to execute the command, among the first machines and the second machines, based on the generated capability set, capability parameters and status parameters of respective machines that are registered in the relation server or that are extractable by the relation server, and the sub-relations.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram showing a system according to an embodiment of the present invention; and

FIGS. 2A and 2B illustrate an embodiment of a scenario that can be applied to the system of FIG. 1.

### DESCRIPTION OF THE PREFERRED EMBODIMENTS

Specific structural or functional descriptions related to embodiments based on the concept of the present invention and disclosed in the present specification are merely illustrated to describe embodiments based on the concept of the present invention, and the embodiments based on the concept of the present invention may be implemented in various forms and should not be interpreted as being limited to the above embodiments described in the present specification.

The embodiments based on the concept of the present invention may be modified in various manners and may have various forms, so that embodiments are intended to be illustrated in the drawings and described in detail in the present specification. However, it should be understood that those embodiments are not intended to limit the embodiments based on the concept of the present invention to specific disclosure forms and they include all changes, equivalents or modifications included in the spirit and scope of the present invention.

The terms such as “first” or “second” may be used to describe various components, but those components should not be limited by the terms. The terms are merely used to distinguish one component from other components, and a first component may be designated as a second component and a second component may be designated as a first component in the similar manner, without departing from the scope based on the concept of the present invention.

It should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. In contrast, it should be understood that a representation indicating that a first component is “directly connected” or “directly coupled” to a second component means that no component is interposed between the first and second components. Other representations describing relationships among components, that is, “between” and “directly between” or “adjacent to,” and “directly adjacent to,” should be interpreted in similar manners.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof that are described in the present specification are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

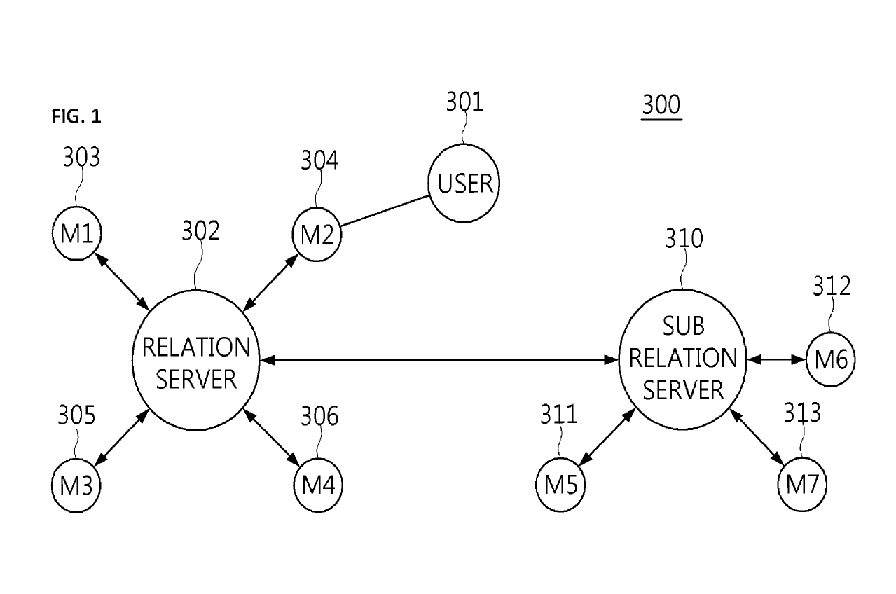

FIG. 1 is a conceptual diagram showing a system according to an embodiment of the present invention.

Referring to FIG. 1, a system 300 according to an embodiment of the present invention may include a relation server 302, machines 303 to 306 associated with the relation server 302, a sub-relation server 310, and machines 311 to 313 associated with the sub-relation server 310.

In FIG. 1, for the convenience of description, a user 303 is illustrated together with the above components, and may be a user or a user terminal.

Although four machines 303 to 306 associated with the relation server 302 and three machines 311 to 313 associated with the sub-relation server 310 are illustrated by way of example, the technical scope of the present invention should not be construed as being limited to any specific number of machines included in the system 300.

Each of the machines 303 to 306 and 311 to 313 may have its own machine profile.

The machine profile means data including various types of information related to each of the machines 303 to 306 and 311 to 313. According to an embodiment, the machine profile may include at least one of the parameters of the machine profile presented in the following Table 1. Each of the machine profile parameters may include at least one sub-parameter.

In the present specification, the term “sub-parameter” may denote a parameter including detailed items for the corresponding parameter.

TABLE 1

| Parameters of | |
|---|---|
| machine profile | Sub-parameters |
| Status | Current operation (active) state |
| | Current availability or unavailability (standby) |
| | Current process |
| | Scheduled termination time of current process |
| | Currently executed function |
| | Scheduled termination time of currently executed |
| | function |
| Capability | Title of process |
| | Input parameter |
| | Output parameter |
| | Process processing time |
| | Process processing condition(s) |
| | Function 1 |
| | Function 2 |
| | . . . |
| | Function n |
| Machine ID | — |
| User ID | — |
| Group ID | — |
| Machine | Operating system type |
| operating | Operating system version |
| system | |
| Machine | Interface protocol(s) between machines |
| interface | Interface parameter(s) between machines |
| | Interface protocol(s) between machines and relation |
| | server |
| | Interface parameter(s) between machines and relation |
| | server |

Referring to Table 1, the sub-parameters of the status parameter may include information about whether each of the machines 303 to 306 and 311 to 313 is currently available or unavailable (i.e. in a standby state), current process, a scheduled termination time for the current process, the currently executed function, and the scheduled termination time of the currently executed function.

The currently executed function may denote the function that is currently being executed among various functions that are executed in order to perform a single process. For example, the currently executed function may be a function such as ‘washing’, ‘rinsing’, or ‘spin-drying’, performed for the process ‘laundering’.

The sub-parameters of the capability parameter may include the title of a process, which can be processed by each of the machines 303 to 306, and 311, an input parameter, an output parameter, a process processing time, a process processing condition, and multiple functions related to the executable task (function 1, function 2, function 3, . . . , function n). The input parameter may refer to information that is input in order to operate the corresponding machine, and the output parameter may refer to information that is output from the corresponding machine depending on the results of operation.

The machine ID parameter denotes a unique identifier allocated to each of the machines 303 to 306 and 311 to 313 to identify each of the machines 303 to 306 and 311 to 313.

The user ID parameter denotes a unique identifier allocated to a user who is capable of utilizing each of the machines 303 to 306 and 311 to 313.

The group ID parameter denotes a unique identifier allocated to a user group (e.g. members of a family, members of a specific company, etc.) that is capable of utilizing each of the machines 303 to 306 and 311 to 313.

The sub-parameters of the machine operating system (OS) parameter may include the type and version of the OS that is used by each of the machines 303 to 306 and 311 to 313.

The sub-parameters of the machine interface parameter may include interface protocols between the machines 303 to 306 and 311 to 313, interface parameters between the machines 303 to 306 and 311 to 313, interface protocols between each machine and the relation server, and interface parameters between each machine and the relation server.

The interface protocols between each machine and the relation server may include interface protocols between each of the machines 303 to 306 and the relation server 302 and interface protocols between each of the machines 311 to 313 and the sub-relation server 310 so that the interface protocols are separated.

The interface parameters between each machine and the relation server may include interface parameters between each of the machines 303 to 306 and the relation server 302 and interface parameters between each of the machines 311 to 313 and the sub-relation server 310 so that the interface parameters are separated.

In accordance with an embodiment, the machine profile may be defined and implemented in the form of a schema having a hierarchical structure. That is, the machine profile may be defined and implemented as a data structure having a structure system such as that given in Table 1. In this case, the machine profile may further include a tag, indicating the last portion of each parameter (or machine profile), in the last portion of each parameter (or the last portion of the machine profile).

The machines 303 to 306 of FIG. 1 are directly managed by the relation server 302 and the machines 311 to 313 are directly managed by the sub-relation server 310. The relation server 302 and the sub-relation server 310 may communicate with each other. In some cases, the machines 303 to 306 and the machines 311 to 313 may be utilized together (collaborate with each other) so as to execute a single command.

That is, the relation server 302 for managing the machines 303 to 306 and the sub-relation server 310 for managing the machines 311 to 313 may be implemented as a nested-centralized model in which they may independently execute a command or may be associated with each other so as to execute a command.

According to an embodiment, each of the relation server 302 and the sub-relation server may perform grouping (or, a sub-grouping) of the machines according to the command transmitted by the user 301. And, the relation server 301 may form relations using sub-relations generated by the result of the sub-grouping of the sub-relation server 310. The term “sub-grouping” may refer to an operation of the sub-relation server 310 grouping the machines 311 to 313 associated with the sub-relation server 310.

The term “relation” in the present specification may mean a concept that includes not only machines associated to collaborate with each other in performing a task (i.e. a machine group), but also a task processing schedule (e.g. the sequence of operations, a task collaborative relation, etc.) required to allow the machines to perform the task.

The term “sub-relation” in the present specification may mean a ‘relation’ between machines formed by the sub-relation server (e.g. 310).

According to an embodiment, the relation server 302 may perform a grouping for the machines 303 to 306 that have been previously registered in the relation server 302 or that are extractable by a communication with the relation server 302 among various machines. And, the sub-relation server 310 may perform a grouping for the machines 311 to 313 that have been previously registered in the sub-relation server 310 or that are extractable by a communication with the sub-relation server 310 among various machines.

The procedure that the relation server 302 groups the machines 303 to 306 may include 1) a procedure that the relation server 302 receives the command, 2) a procedure that the relation server 302 generate a capability set required to perform the command by analyzing the received command, and 3) a procedure the relation server 302 operates based on the generated capability set, and a machine profile (e.g. a capability parameter and a status parameter) of the machines 303 to 306.

The procedure that the sub-relation server 310 groups the machines 311 to 313 may include 1) a procedure that the sub-relation server 310 receives the command, 2) a procedure that the sub-relation server 310 generate a capability set required to perform the command by analyzing the received command, and 3) a procedure the sub-relation server 310 operates based on the generated capability set, and a machine profile (e.g. a capability parameter and a status parameter) of the machines 311 to 313.

According to another embodiment, if there is a task (or a function) that cannot be processed by the machines 303 to 306 associated with the relation server 302 or that requires distributed processing, the relation server 302 may transmit a command required to process the corresponding task (or function) to the sub-relation server 310.

In this case, similar to the relation server 302, in compliance with the command received from the relation server 302, the sub-relation server 310 may generate a capability set required to execute the received command, and may sub-group the machines 311 to 313 based on the generated capability set and the machine profiles of the machines 311 to 313, for example, the capability parameters and status parameters thereof.

That is, the relation server 302 may group machines required to execute the command by analyzing the command of the user 301, together with the sub-relation server 310, and thus the relation server 302 may extend machines that may be grouped by the sub-relation server 310. Further, the system 300 of FIG. 1 has an advantage in that, when a command input by the user 301 is executed, a load imposed on the relation server 302 may be distributed to the sub-relation server 310.

In the present specification, the term ‘analysis of a command’ may be used interchangeably with the term ‘analysis of a task corresponding to a command’.

The relation server 302 may generate a relation profile based on the formed relations. The relation profile will be described in detail with reference to Table 2.

According to an embodiment, the relation server 302 may request an intervention of a user to the user 301 according to the processes included in the relation profile. The intervention of the user may include an approval or a selection of the user related to an execution of the processes. In this case, the user 301 may transmit a result of the approval for all of the processes or the selection for a part of the processes to the relation server 302, by responding to the request from the relation server 302. The said user intervention step may be performed at various times according to an embodiment. For example, the intervention of the user may be performed after the relation profile is generated or be performed before an addition work is conducted.

According to another embodiment, the relation server 302 may request the intervention of the user to the user 301 only when a process result of the processes included in the relation profile make a critical effect on the user 301.

The relation server 302 may re-group the machines 303 to 306, and 311 to 313 according to the intervention (e.g. the approval of the selection) of the user 301, and may generate a new relations of the re-grouped machines. And, the relation server 302 may generate a new relation profile according to the new relations.

According to an embodiment, relation profile may include at least one of the parameters presented in the following Table 2. Each of the parameters of the relation profile may include at least one sub-parameter.

The term “task” in the present specification may mean a set of processes (or functions) that needs to be performed based on the results of analyzing the command input from the user 301. And, the term “relation profile” in the present specification may broadly mean data representing relations formed to perform a task.

TABLE 2

| Parameters of | |
|---|---|
| relation profile | Sub-parameters |
| Capability set | Capability 1 |
| | . . . |
| | Capability n |
| Grouped machines | Machine ID 1 |
| | . . . |
| | Machine ID n |
| Work group ID | — |
| Task description | — |
| Task processing | Process 1 |
| schedule | Process start time |
| | Process start condition(s) |
| | Allocated machine ID |
| | Start time of function 1 |
| | Function 1 |
| | . . . |
| | Start time of function n |
| | function n |
| | Predicted termination time of process 1 |
| | Interface parameter |
| | Termination condition(s) of process 1 |
| | . . . |
| | Process n |
| | Process start time |
| | Process start condition(s) |
| | Allocated machine ID |
| | Start time of function 1 |
| | function 1 |
| | . . . |
| | Start time of function n |
| | Function n |
| | Predicted termination time of process n |
| | Interface parameters |
| | Termination condition(s) of process n |

Referring to Table 2, the parameters of the relation profile may include a capability set parameter, grouped machine parameters, a work group ID parameter, a task description parameter, a task processing schedule parameter, etc.

The capability set parameter may include information about capability parameters, which are required for relevant task, and machines may be grouped based on the capability set parameters.

The grouped machine parameters may include information about the machine IDs (machine ID 1, . . . , machine ID n) of machines grouped to perform the relevant task.

The work group ID parameter may denote the ID required to identify the entire group of the grouped machines.

The task description parameter may include various types of additional information related to the relevant task. For example, the task description parameter may include details about the tasks for the relevant task in the form of text.

The task processing schedule parameter may include relations (e.g. a processing sequence) between multiple processes (process 1, . . . , process n) and sub-parameters related to the respective processes (process 1, . . . , process n).

According to an embodiment, the sub-parameters of the task processing schedule parameter may include the process start time of each process, the start condition(s) of each process, the machine IDs of machines allocated, the functions used, the start time of each of the functions, the predicted termination time of the process, interface parameters, the termination condition(s) of the process, etc.

According to an embodiment, the relation profile may be defined and implemented in the form of a schema having a hierarchical structure. That is, the relation profile may be defined and implemented as a data structure having a structure system, such as that given in Table 2. In this case, the relation profile may further include a tag, indicating the last portion of each parameter (or the relation profile), in the last portion of each parameter (or the last portion of the relation profile).

In the present specification, the term “capability set” may be used as a concept having a level which is equivalent to the task. For example, work, that is, a capability set corresponding to a task, such as “housework” may be composed of processes (or functions) such as “cleaning”, “doing the dishes”, and “doing the laundry”.

According to an embodiment, the relation server 302 may list the machine ID parameters of the respective machines 303 to 306 and 311 to 313 grouped to execute the command and arrange the listed machine ID parameters according to the sequence of operations suitable for the execution of the command.

In this case, in the arrangement corresponding to the operation sequence, the status parameters of respective machines 303 to 306 and 311 to 313 may be taken into consideration. For example, when a relevant machine is found to be currently in an active state using the sub-parameters of the machines 303 to 306 and 311 to 313, the sequence of operations may be arranged in consideration of available times using the scheduled termination time parameter for the current active state.

For example, when a relevant machine is found to be currently in an available state using the sub-parameter indicating current availability or unavailability (standby state), among the sub-parameters of the machines 303 to 306 and 311 to 313, the operations of the machines may be arranged according to the sequence most suitable for the execution of the command.

According to the determined operation sequence, the relation server 302 may execute the command received from the user 301 by requesting each of the machines 303 to 306 and 311 to 313 to perform tasks.

According to an embodiment, when the relation server 302 requests the machines 311 to 313 to perform tasks, the sub-relation server 310 may relay the task request.

In the system 300 of FIG. 1, the machines 303 to 306 and 311 to 313 may entirely controlled by the relation server 302 and the sub-relation server 310, and thus there is no need to exchange data between the machines 303 to 306 and 311 to 313.

The relation server 302 and the sub-relation server 310 are not limited as to the locations or forms thereof as long as they are capable of communicating with the machines 303 to 306 and 311 to 313. For example, each of the relation server 302 and the sub-relation server 310 may be implemented using a smart phone.

The machine profiles of the machines 303 to 306 and 311 to 313 may be previously registered in the relation server 302 or the sub-relation server 310, or may be transmitted to the relation server 302 or the sub-relation server 310 at the request of the relation server 302 or the sub-relation server 310. According to an embodiment, when the machine profiles are previously registered, the relation server 302 or the sub-relation server 310 may fixedly store the capability parameters, machine ID parameters, user ID parameters, group ID parameters, machine OS parameters, and machine interface parameters, and may update the status parameters while communicating with the machines 303 to 306 and 311 to 313.

The relation server 302 or the sub-relation server 310 may always be maintained in the state in which it is capable of communicating with the machines 303 to 306 and 311 to 313 by setting interface protocols and protocol parameters to be used to communicate with the machines 303 to 306 and 311 to 313 using the machine profiles.

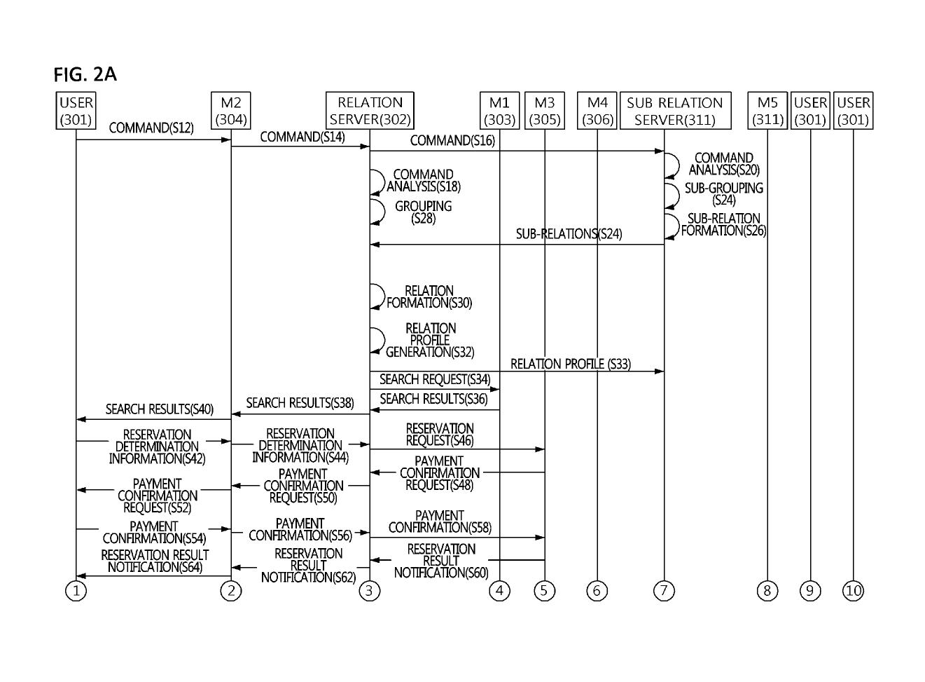

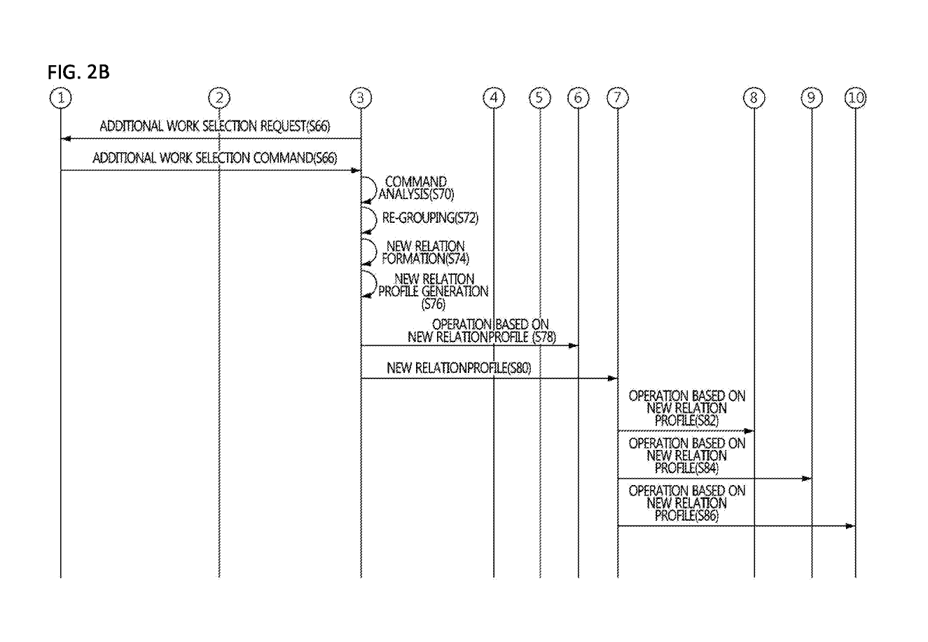

A method for operating the relation server 302 and the sub-relation server 310 will be described in greater detail below with reference to the scenario of FIGS. 2A and 2B.

FIGS. 2A and 2B illustrate an embodiment of a scenario that can be applied to the system of FIG. 1.

Referring to FIGS. 1 and 2A and 2B, it is assumed that, in FIGS. 2A and 2B, the first machine 303 is a movie search engine, the second machine 304 is a smart phone, the third machine 305 is a machine having a movie reservation function (e.g. a communication terminal in which a movie reservation application is installed), the fourth machine 306 is a boiler control machine having a communication function, the fifth machine 311 is a washing machine, the sixth machine 312 is a vacuum cleaner, and the seventh machine 313 is a wet mop cleaner.

The second machine 304 may receive a command from the user 301 at step S12. According to an embodiment, the command may be received via email, a social networking service (SNS), or a messenger.

The second machine 304 may forward the command received from the user 301 to the relation server 302 at step S14.

The relation server 302 may forward the received command to the sub-relation server 310 at step S16.

Each of the relation server 302 and the sub-relation server 310 may analyze the command received from the relation server 302 at step S18 and S20, generate a capability set required to execute the analyzed command based on a result of the analysis.

The relation server 302 may group the machines 303 to 306 based on the generated capability set and the machine profiles of the machines 303 to 306, for example, the capability parameters and status parameters thereof, generated based on the result of the analysis at step S20.

The sub-relation server 310 may sub-group the machines 311 to 313 based on the generated capability set and the machine profiles of the machines 311 to 313, for example, the capability parameters and status parameters thereof, generated based on the result of the analysis at step S22.

The sub-relation server 310 may form sub-relations between the sub-grouped machines 311 to 313 based on the capability set and the machine profiles of the respective machines 311 to 313, for example, the capability parameters and status parameters thereof, at step S26.

The sub-relation server 310 may transmit data about the formed sub-relations to the relation server 302 at step.

The relation server 302 may form relations using the machine group grouped by the relation server 302 and sub-relations transmitted from sub-relation server 310 at step S30.

According to an embodiment, the relations may include information about the grouped machines grouped by the relation server 032, information about the sub-grouped machines sub-grouped by the sub-relation server and information about a total task processing schedule.

The relation server 302 may generate a relation profile based on the generated relations at step S32, and may transmit the generated relation profile to the sub-relation server 310 at step S33

According to an embodiment, the relation server 302 may use machine profiles including the capability parameters and the status parameters of the machines 303 to 306 and 311 to 313, previously registered in the relation server 302.

According to another embodiment, the relation server 302 may also use machine profiles acquired from a query that is transmitted from the relation server 302 to the machines 303 to 306 and 311 to 313. Thereafter, the relation server 302 may perform management so that the corresponding machines perform required operations at required times depending on the generated relation profile. And, the sub-relation server 310 may perform management so that the corresponding machines perform required operations at required times depending on the relation profile which is transmitted form the relation server 302 at step S33.

The relation server 302 may deliver a ‘movie search’ request to the first machine 303 at step S34.

In response to the request of the relation server 302, the first machine 303 may search for information about movies that meet movie search conditions input by the user 301 (e.g. a movie title, a movie theater, a synopsis, a running time, or the like), and may transmit the found movie information to the user 301 via the relation server 302 and the second machine 304 at steps S36, S38, and S40.

The user 301 enters information about the determination to make a reservation (e.g. the selected movie, the selected movie theater, the movie start time, the number of tickets to be reserved, etc.) in response to the found movie information, and may deliver the information about the determination to make a reservation (reservation determination information), together with a reservation command, to the relation server 302 via the second machine 304 at steps S42 and S44.

The relation server 302 may transmit a reservation request to the third machine 305 based on the received reservation determination information at step S46.

The third machine 305 may reserve a movie corresponding to the reservation determination information, and may transmit a payment confirmation request to the user 301 via the relation server 302 and the second machine 304 at steps S48, S50, and S52.

The user 301 may transmit payment confirmation to the third machine 305 via the second machine 304 and the relation server 302 at steps S54, S56, and S58.

The third machine 305 may reserve the movie in response to payment confirmation from the user 301, and may provide notification of the results of the reservation to the user 301 via the relation server 302 and the second machine 304 at steps S60, S62, and S64.

The relation server 302 may transmit a request, which is required in order to obtain the selection or approval of additional work items that can be additionally performed in compliance with the command of the user 301 transmitted at step S12, to the user 301 at step S66.

According to an embodiment, the relation server 302 may transmit information about a list of additional work items, information about machines for processing the additional work items, and information about the sequence (or schedule), in which the additional work items are to be processed, to the user 301.

The user 301 may select and input additional work items to be conducted, and may transmit a command for selecting the input additional work items to the relation server 302 at step S68.

The relation server 302 may analyze the additional work selection command transmitted from the user 301 at step S70, generate a capability set required to execute the command based on the results of the analysis, and re-group the machines 306 and 311 to 313, which will collaborate in the performance of the additional work items selected by the user 301, based on the generated capability set, at step S72.

The relation server 302 may form new relations between the machines 306 and 311 to 313 based on the capability parameters and the status parameters of the respective re-grouped machines 306 and 311 to 313 at step S74.

The relation server 302 may generate a new relation profile based on the newly formed relations at step S76.

Thereafter, the relation server 302 may perform management so that the corresponding machines perform required operations at required times based on the newly generated relation profile.

For example, the relation server 302 may schedule the operation of a boiler so that the boiler is driven via the fourth machine 306 in accordance with the time at which the movie is to be terminated based on movie reservation information at step S78.

The relation server 302 may transmit the new relation profile to the sub-relation server 310 at step S80.

The sub-relation server 310 may operate the fifth machine 311, the sixth machine 312, and the seventh machine 313 based on the new relation profile at steps S82, S84, and S86.

For example, under the control of the sub-relation server 310, the fifth machine 311 may perform an operation of doing the laundry, the sixth machine 312 may perform an operation of cleaning the floor, and the seventh machine 313 may perform an operation of wet mopping the floor according to the set sequence of operations and at designated times.

In this way, in the system 300 of FIG. 1, the relation server 302 may process the command input from the user 301 using the sub-relations formed by the sub-relation server 310.

According to an embodiment, after the execution of the command has been completed, the relation server 302 may release the formed relations and delete the relation profile, and the sub-relation server 310 may release the formed sub-relations.

Although the present invention has been described with reference to the embodiments illustrated in the drawings, those skilled in the art will understand that various modifications and other equivalent embodiments are possible from the above embodiments. Therefore, the technical scope of the present invention should be defined by the technical spirit of the accompanying claims.

The method according to the embodiments may be implemented as a program that can be executed by various computer means. In this case, the program may be recorded on a computer-readable storage medium. The computer-readable storage medium may include program instructions, data files, and data structures solely or in combination. Program instructions recorded on the storage medium may have been specially designed and configured for the present disclosure, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present disclosure, and vice versa.

In accordance with the present invention, the method and system according to embodiments of the present invention are advantageous in that machines that are to execute a command may be grouped based on the capability parameters and the status parameters of machines, and optimal relations between the machines grouped to execute the command may be formed.

Further, the method and system according to embodiments of the present invention are advantageous in that relations between machines may be extended via association between a relation server and a sub-relation server.

As described above, although the embodiments have been described with reference to a limited number of embodiments and drawings, those skilled in the art will appreciate that various changes and modifications are possible from the above descriptions. For example, even if the above-described technologies are performed in a sequence differing from that of the described method, and/or components such as a system, a structure, a device, and a circuit are coupled or combined in a way differing from that of the described method or are replaced with or substitute other components or equivalents, suitable results can be achieved.

Therefore, it should be understood that other embodiments and examples and equivalents of the accompanying claims belong to the scope of the accompanying claims.

What is claimed is:

1. A method for operating a relation server, comprising:
generating, by a relation server, a capability set required to execute a command by analyzing the command;
grouping, by the relation server, machines that are to execute the command, based on the generated capability set, capability parameters and status parameters of respective machines that are previously registered in the relation server or that are extractable by the relation server; and
generating, by the relation server, relations using sub-relations formed by a machine group grouped by the relation server and a sub-relation server.

2. The method of claim 1, wherein each of the capability parameters includes sub-parameters related to at least one of a title of an executable process, an input parameter, an output parameter, a process processing time, process processing conditions, and executable functions.

3. The method of claim 1, wherein each of the status parameters includes sub-parameters related to at least one of a current active state, current availability or unavailability, a current process, a scheduled termination time for the current process state, a currently executed function, and a scheduled termination time of the currently executed function.

4. The method of claim 1, wherein:
a machine profile including information about each of the machines includes a capability parameter and a status parameter, and
the machine profile further includes at least one of a machine ID parameter, a user ID parameter, a group ID parameter, a machine operating system parameter, and a machine interface parameter.

5. The method of claim 4, wherein the machine operating system parameter includes sub-parameters related to a type and a version of an operating system used by each of the machines.

6. The method of claim 5, wherein the machine interface parameter includes sub-parameters related to interfaces and interface protocols between the machines, interfaces and interface protocols between each machine and the relation server, and interfaces and interface protocols between each machine and the sub-relation server.

7. The method of claim 1, wherein the sub-relation server sub-groups machines that are to execute the command together, based on the capability set generated as a result of analysis on the command by the sub-relation server itself and capability parameters and status parameters of respective machines that are previously registered in the sub-relation server or that are extractable by the sub-relation server, and forms the sub-relations of sub-grouped machines.

8. The method of claim 7, wherein the sub-relation includes information about the sub-grouped machines and information about a task processing schedule of the sub-grouped machines.

9. The method of claim 8, wherein the relations include information about the grouped machines grouped by the relation server, information about the sub-grouped machines sub-grouped by the sub-relation server and information about a total task processing schedule.

10. The method of claim 9, further comprising:
generating, by the relation server, a relation profile based on the relations.

11. The method of claim 10, further comprising:
transmitting, by the relation server, the relation profile to the sub-relation server.

12. The method of claim 10, wherein the relation profile includes at least one of a capability set parameter, grouped machine parameters, a work group ID parameter, a task description parameter, and a task processing schedule parameter.

13. The method of claim 12, wherein the task processing schedule parameter includes sub-parameters related to at least one of a process start time of each process, process start conditions, machine IDs of allocated machines, functions that are used, a start time of each of the functions, a predicted process termination time, interface parameters, and process termination conditions.

14. The method of claim 13, further comprising:
operating, by the relation server, the grouped machines according to a task processing schedule of operations included in the relation profile.

15. The method of claim 14, further comprising, after completing the execution of the command:
releasing, by the relation server, the relations; and
releasing, by the sub-relation server, the sub-relations.

16. The method of claim 10, further comprising:
requesting, by the relation server, an intervention of a user based on processes included in the relation profile.

17. The method of claim 16, wherein the intervention of the user includes an approval or a selection of the user related to an execution of the process.

18. The method of claim 17, further comprising:
re-grouping, by the relation server, the machines according to the approval or the selection of the user; and
forming, by the relation server, new relations between the re-grouped machines.

18. The method of claim 17, further comprising:
generating, by the relation server, a new work profile based on the new relations.

19. A system comprising:
multiple first machines;
multiple second machines;
a sub-relation server for managing sub-relations between the multiple second machines; and
a relation server for managing relations between the first machines and the second machines using the sub-relations,
wherein the relation server generates a capability set required to execute a command by analyzing the command, and form relations between machines that are to execute the command, among the first machines and the second machines, based on the generated capability set, capability parameters and status parameters of respective machines that are registered in the relation server or that are extractable by the relation server, and the sub-relations.
